(19) United States
(12) Patent Application Publication
(10) Pub. No.: US 2012/0043840 A1
(43) Pub. Date: Feb. 23, 2012

(54) ELECTRIC MOTOR AND MOTOR WITH A REDUCTION GEAR

(76) Inventors: Tomohiko Annaka, Kiryu-shi (JP); Satoru Negishi, Kiryu-shi (JP); Naoki Shioda, Kiryu-shi (JP); Gensaku Yamakami, Kiryu-shi (JP)

(21) Appl. No.: 13/266,637

(22) PCT Filed: Apr. 28, 2010
(86) PCT No.: PCT/JP10/03058

§ 371 Date: Oct. 27, 2011

(30) Foreign Application Priority Data
May 1, 2009 (JP) 2009-112131

(51) Int. Cl. H02K 23/04; H02K 7/116

(52) U.S. Cl. 310/83; 310/154.24

(57) ABSTRACT

In an electric motor, permanent magnets are disposed on flat sections of a peripheral wall of the yoke, which is formed to be polygonal seen in plan view in the axial direction, a first bearing section which rotatably supports one end of the rotary shaft is integrally formed on a bottom part of the yoke, and a brush holder accommodating section capable of accommodating a brush holder unit that holds the brushes is integrally formed at an opening of the yoke.

### TECHNICAL FIELD

The present invention relates to an electric motor installed, for example, in a vehicle, and to an electric motor with a gear reduction using such a motor.

The present application claims priority based on the patent application 2009-112131, filed on May 1, 2009 in Japan, the content of which is incorporated herein by reference.

### BACKGROUND ART

An electric motor, for example, has a plurality of segmented permanent magnets disposed on the inner peripheral surface of a cylindrically shaped yoke with a bottom, and an armature that is rotatably provided further to the inside in the radial direction than the permanent magnetic. The armature has an armature core that is fitted and fixed to the outside of a rotary shaft, and a commutator provided with a plurality of segments. The armature core is provided with a plurality of teeth that extend toward the outside in the radial direction, with a plurality of long slots provided between the teeth in the axial direction. Windings are passed through from these slots, wound as concentrated winding or distributed windings for each of the teeth.

The windings are electrically conductive with the segments of the commutator. Brushes are in sliding contact with each segment, so that electrical current is supplied to the windings via the brushes. When electrical current is supplied to the windings, a magnetic field is formed, and the armature is rotated by magnetic attractive force and repulsive force occurring between this magnetic field and the permanent magnets.

In the case of using a segmented permanent magnet, because air gaps are formed between each of the permanent magnets, the change in the magnetic flux becomes large at the boundaries of the two ends of the permanent magnetic in the peripheral direction. For this reason, when each of the teeth passes the ends of a permanent magnet, there is a large change in the forces of magnetic attraction and magnetic repulsion with respect to each tooth, resulting in an increase in cogging torque.

Given this, art has been proposed (for example, refer to Patent Document 1 and Patent Document 2) in which the air gap between the permanent magnets and the armature core is made gradually larger from the center of the permanent magnets toward both ends of the permanent magnets in the peripheral direction, so as to reduce the change in the magnetic forces of attraction and repulsion when each of the teeth passes the ends of the permanent magnets.

Art has also been proposed (for example, refer to Patent Document 3) in which the material thickness of the permanent magnets at both ends thereof in the peripheral direction is made greater than the material thickness at the center part, while maintaining the air gap with respect to the armature core, so as to prevent cracking of the permanent magnets.

Patent Document 1: Japanese Unexamined Patent Application, First Publication No. JPA S56-94958

Patent Document 2: Japanese Unexamined Patent Application, First Publication No. JPA 2005-20914

Patent Document 3: Japanese Unexamined Patent Application, First Publication No. JPA H9-224337

### DISCLOSURE OF INVENTION

### Problem to be Solved by the Invention

In the above-described prior art, however, because the segmented permanent magnets are formed in the shape of roof tiles, there is a restriction on the thickness to which the permanent magnets can be processed. For this reason, the permanent magnets must be made larger than necessary, and particularly in the case of forming rare earth magnets made of neodymium sintered magnets or the like, machining is difficult, and it is difficult to achieve a thin material thickness.

Given this, the present invention was made in consideration of the above-described situation, and provides an electric motor and an electric motor with a reduction gear, which is lightweight, compact, and low-cost, using the smallest required permanent magnets, while reducing the cogging torque, and which provides improved motor characteristics.

### Means for Solving the Problem

(1) To solve the above-described problem, an electric motor according to a first aspect of the present invention includes: a bottomed cylindrical yoke; six flat-sheet permanent magnets fixed to an inner peripheral surface of the yoke; an armature rotatably supported further inward in the radial direction from the permanent magnets, and one pair of brushes which supply electricity to the armature, wherein the armature has a rotary shaft; an armature core which is fitted and fixed to the outside of the rotary shaft; and a commutator provided adjacently to the armature core with nine segments disposed in the peripheral direction, and the armature core has: nine teeth extending toward the outside in the radial direction and 9 slots formed between the teeth and extending along the axial direction, wherein windings are wound around each of the teeth and the end part of the windings connected to the segments, the permanent magnets are disposed on flat sections of a peripheral wall of the yoke, which is formed to be polygonal seen in plan view in the axial direction, a first bearing section which rotatably supports one end of the rotary shaft is integrally formed on a bottom part of the yoke, a brush holder accommodating section capable of accommodating a brush holder unit that holds the brushes is integrally formed at an opening of the yoke, and electricity is supplied to the windings by a sliding contact by the brushes with the segments.

In this manner, by using flat-sheet permanent magnets in a 6-pole, 9-slot, 9-segment electric motor, the need for complex processing of the permanent magnets is eliminated. For this reason, even in the case in which rare earth magnets are used as the permanent magnets, it is possible to easily make thin permanent magnets by machining and the like. It is possible, therefore, to achieve light weight and low cost, and to achieve an electric motor that is overall compact.

Also, by forming the peripheral wall of the yoke in a polygonal shape when seen in plan view in the axial direction and disposing the permanent magnets on the flat portions, it is possible to securely hold even flat-sheet permanent magnets to the inner peripheral surface of the yoke. It is additionally possible to cause the air gap between the permanent magnets and the armature core to increase gradually from the center of the permanent magnet toward both ends thereof in the peripheral direction. For this reason, it is possible to reduce the change in the magnetic forces of attraction and repulsion as each of the teeth passes the two ends of a permanent magnet, thereby enabling a reduction of the cogging torque.

It is also possible to increase the outer diameter of the armature core to the extent that the thickness of the permanent magnets is reduced, without increasing the outer diameter of the yoke. For this reason, it is possible to reserve more space for windings than conventionally, enabling an improvement in torque performance by increasing the number winding turns.

By integrally forming the brush holding accommodating section that accommodates the brush holder unit with the yoke, it is possible to achieve a more compact electric motor than in the case in which a separate brush holder unit is mounted to the electric motor.

(2) In the electric motor according to the first aspect of the present invention, the brush holder unit may be formed to enable fitting and holding inside the brush holder accommodating section, and a second bearing unit which rotatably supports the other end of the rotary shaft may be integrally formed on the brush holder unit.

By adopting this constitution, positioning of the brush holder unit is facilitated. Also, because the brush holder accommodating section is formed integrally with the yoke, it is easy to position the brush holder unit with respect to the yoke.

For this reason, it is possible to perform precise relative positioning between the first bearing section formed integrally on the bottom wall of the yoke and the second bearing unit of the brush holder unit. It is therefore possible to prevent undue stress on the rotary shaft or on the bearings, and also possible to prevent an increase in the torque load on the rotary shaft due to relative positioning offset at each of the bearing sections.

(3) In the electric motor according to the first aspect of the present invention, the brush holder unit and the brush holder accommodating section may be formed to have a shape that is an elongated circle seen in plan view, a peripheral wall of the brush holder accommodating section having two flat sections and arc-shaped sections that link the flat sections in the peripheral direction, wherein of the flat sections of the yoke, two flat sections that are in mutual opposition with the rotary shaft as the center and a flat section of the brush holder accommodating section may be flush.

By adopting this constitution, it is possible to achieve a flattened and compact electric motor.

(4) In the electric motor according to the first aspect of the present invention, the one pair of brushes may be disposed, on both ends in the longitudinal direction of the brush holder unit, to be in opposition about the rotary shaft as the center, and a resilient member which impels the brushes toward the commutator may be provided in the brush holder unit.

By adopting this constitution, it is possible to achieve a further flattened and compact electric motor.

(5) In the electric motor according to the first aspect of the present invention, an outer flange may be integrally formed at the opening edge of the brush holder accommodating section, a depression may be formed at least at one position in a connecting part between the peripheral wall of the brush holder accommodating section and the outer flange, and a protrusion capable of being placed in the depression may be provided in the outer peripheral edge of the brush holder unit.

By adopting this constitution, it is possible to perform accurate positioning of the brush holder unit with respect to the brush holder accommodating section. For this reason, it is possible to improve the installation precision of the brush holder unit, and improve the ease of installing the brush holder unit.

(6) In the electric motor according to the first aspect of the present invention, in the yoke a circular section having a shape that is substantially circular seen in plan view in the axial direction may be formed in a region between the proximity of the bottom wall of the peripheral wall and the first bearing section.

In the case in which the peripheral wall of the yoke is made polygonal when seen in plan view in the axial direction and the first bearing section is formed on the bottom wall of the yoke, if the yoke is formed, for example, by deep drawing of a metal sheet, there is a risk that, when forming the flat sections of the peripheral wall, the first bearing section will be pulled, and the roundness of the first bearing section will worsen. Also, to improve the roundness of the first bearing section, the number of pressing operations increases, thereby risking an increase in processing cost.

However, by forming a circular section in a region from the proximity of the bottom wall of the peripheral wall of the yoke up to the first bearing section, it is possible to achieve uniform pulling around the entire periphery of the first bearing section when operations such as deep drawing are performed, thereby enabling an improvement of the roundness of the first bearing section and a reduction of the processing cost.

(7) In the electric motor according to the first aspect of the present invention, the permanent magnets may be formed to be long in the axial direction and also may be disposed so that sides in the short direction are at an inclination with respect to a straight line along the axial direction.

By adopting this constitution, it is possible to skew the permanent magnets with respect to the teeth. For this reason, it is possible to further reduce the change in magnetic flux of the permanent magnet with respect to the teeth when the armature rotates and therefore it is possible to further reduce the cogging torque.

(8) In the electric motor according to the first aspect of the present invention, the peripheral wall of the yoke may be formed to be a hexagon seen in plan view in the axial direction.

By adopting this constitution, it is possible to make the peripheral wall of the yoke flat, while securely holding six permanent magnets to the peripheral wall of the yoke.

(9) In the electric motor according to the first aspect of the present invention, the peripheral wall of the yoke may be formed to be a dodecagon seen in plan view in the axial direction.

By adopting this constitution, it is possible to make the spacing between the angles about the center of the rotary shaft of the peripheral wall that opposes the rotary shaft smaller, compared to forming the peripheral wall of the yoke to have a hexagonal shape when seen in plan view in the axial direction. For this reason, it is possible to further reduce the size of the overall yoke, while securely holding the flat sheet-like permanent magnets to the peripheral wall of the yoke.

(10) In the electric motor according to the first aspect of the present invention, a positioning protrusion may be formed on the inner surface of the peripheral wall of the yoke, between each permanent magnet.

By adopting this constitution, because it is possible to easily position the permanent magnets, it is possible to improve the ease of mounting the permanent magnets.

(11) In the electric motor according to the first aspect of the present invention, the other end of the rotary shaft may protrude from the brush holder unit, and a linking section which transmits rotation of the rotary shaft to an external apparatus may be provided at protruding position, and the linking section may be able to be attached to and removed from the external apparatus.

By adopting this constitution, in the case in which an electric motor is mounted to an external apparatus, it is possible to improve the general usefulness of the electric motor, without the need to provide a motor for each external apparatus.

(12) A motor with a gear reduction according to a second aspect of the present invention includes: the motor of the first aspect of the present invention and an external apparatus provided with a reduction mechanism, wherein the other end of the rotary shaft protrudes from the brush holder unit, and a linking section which transmits rotation of the rotary shaft to the external apparatus is provided at protruding position, and the reduction mechanism and the rotary shaft of the armature are linked via the linking section.

By adopting this constitution, it is possible to not only achieve light weight, compactness, and reduced cost by using the smallest required permanent magnets, while reducing the cogging torque, but also to provide a motor with a reduction gear that provides improved motor characteristics.

### Effect of the Invention

According to the present invention, by using flat-sheet permanent magnets in a 6-pole, 9-slot, 9-segment electric motor, the need for complex processing of the permanent magnets is eliminated. For this reason, even in the case of using, for example, rare earth magnets as the permanent magnets, it is easy to form thin permanent magnets by machining or the like. It is therefore possible to achieve lightweight permanent magnets at a low cost, and to achieve compactness for the overall electric motor.

Also, by forming the peripheral wall of the yoke to be a polygonal shape seen in plan view in the axial direction and disposing the permanent magnets in the flat sections, even when using flat sheet-like permanent magnets, secure mounting thereof to the inner peripheral wall of the yoke is possible. Additionally, it is possible to gradually increase the air gap between the permanent magnets and the armature core from the center of the permanent magnet towards both ends thereof in the peripheral direction. By doing this, it is possible to reduce the change in the magnetic forces of attraction and repulsion as each tooth passes the ends of the permanent magnet, thereby enabling a reduction of the cogging torque.

It is also possible to make the outer diameter of the armature core larger to the extent that the material thickness of the permanent magnets is reduced, without increasing the outer diameter of the yoke. For this reason, it is possible to reserve more space for windings than conventionally, enabling an improvement in torque performance by increasing the number of winding turns.

Because the brush holder accommodating section that accommodates the brush holder unit is formed integrally with the yoke, the electric motor is more compact than in the case in which a separate brush holder unit is mounted to the electric motor.

### BRIEF DESCRIPTION OF THE DRAWINGS

FIG. 1 is an oblique view of a motor with a reduction gear according to a first embodiment of the present invention.

FIG. 2 is an exploded oblique view of a motor with a reduction gear according to the first embodiment of the present invention.

FIG. 3A is an exploded oblique view of an electric motor in the first embodiment of the present invention.

FIG. 3B is a drawing showing the electric motor in the first embodiment of the present invention, this showing an enlarged view of the armature in FIG. 3A.

FIG. 4A is a front elevation showing the motor case in the first embodiment of the present invention.

FIG. 4B is a drawing showing the motor case in the first embodiment of the present invention, this showing a cross-sectional view along the line A-A in FIG. 4A.

FIG. 5 is a plan view of the brush holder unit in the first embodiment of the present invention.

FIG. 6 is an exploded oblique view of the worm reduction mechanism in an embodiment of the present invention.

FIG. 7 is a cross-sectional view of the motor case in a second embodiment of the present invention.

FIG. 8A is a side elevation showing the motor case in a third embodiment of the present invention.

FIG. 8B is a drawing showing the motor case in the third embodiment of the present invention, this showing a cross-sectional view along the line B-B in FIG. 8A.

FIG. 9A is a side elevation showing the motor case in a fourth embodiment of the present invention.

FIG. 9B is a drawing showing the motor case in the fourth embodiment of the present invention, this showing a cross-sectional view along the line C-C in FIG. 9A.

FIG. 10A is a drawing showing the motor case in a fifth embodiment of the present invention.

FIG. 10B is a drawing showing the motor case in the fifth embodiment of the present invention, this showing a cross-sectional view along the line D-D in FIG. 10A.

FIG. 11 is a side cross-sectional view showing another form of the yoke section in the fifth embodiment of the present invention.

### BEST MODE FOR CARRYING OUT THE INVENTION

### First Embodiment

### Motor with a Reduction Gear

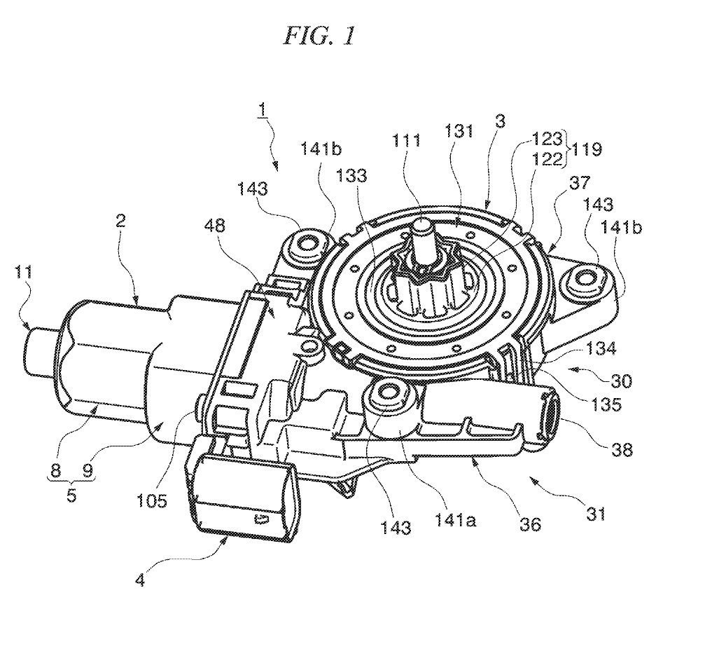

The first embodiment of the present invention will be described below, based on FIG. 1 to FIG. 6.

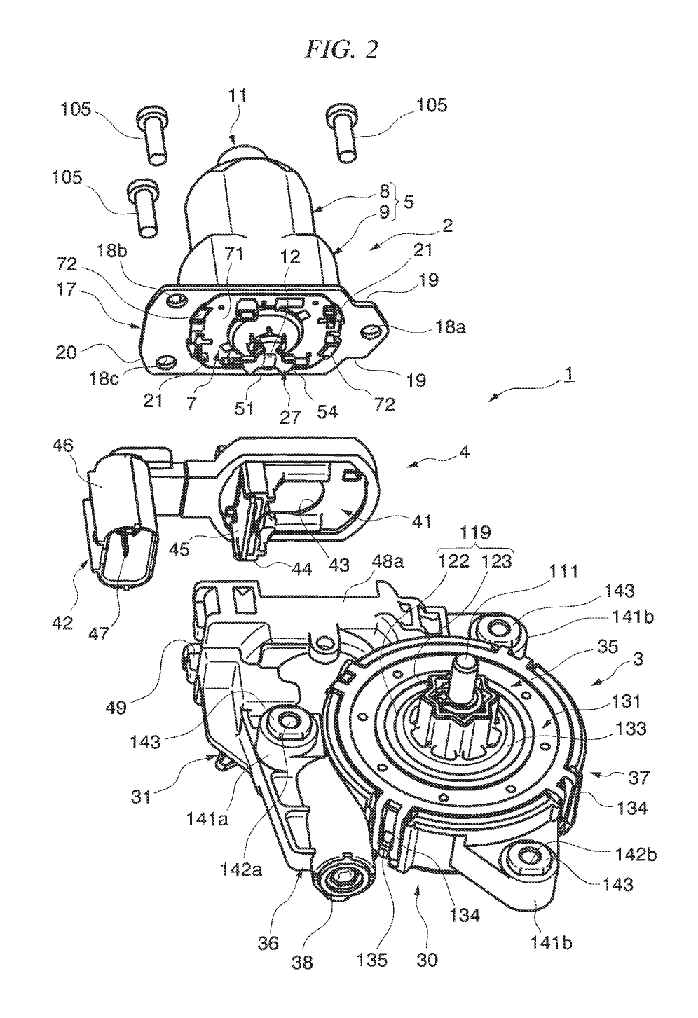

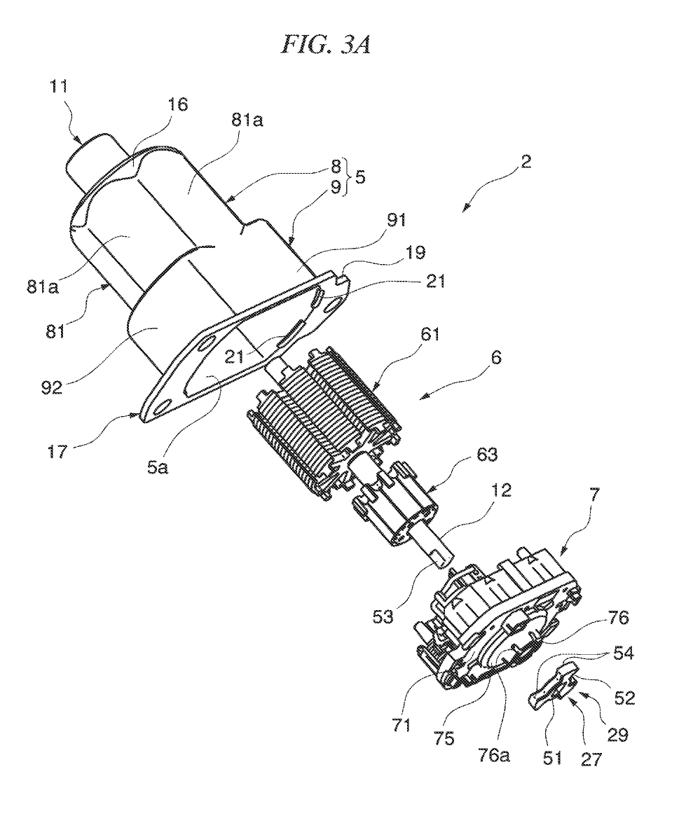

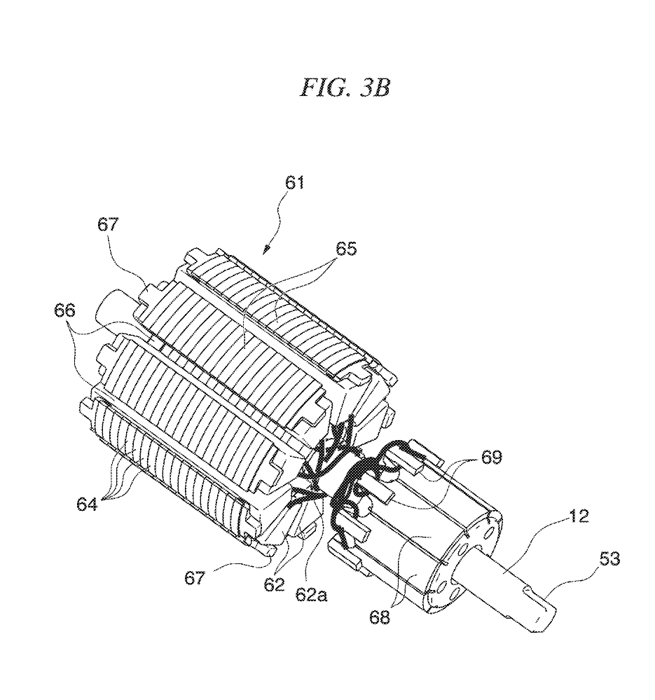

FIG. 1 is an oblique view of motor with a reduction gear 1. FIG. 2 is an exploded oblique view of the motor with a reduction gear 1. FIG. 3A and FIG. 3B show the electric motor 2, FIG. 3A being an exploded oblique view, and FIG. 3B being an enlarged view of the armature 6 of FIG. 3A.

As shown in FIG. 1 to FIG. 3B, the motor with a reduction gear 1 is used, for example, as the drive source for a power window of a vehicle, and is provided with an electric motor 2 and a worm reduction mechanism 3 linked to the rotary shaft 12 of the electric motor 2, a connector unit 4 being provided to supply electrical power to the electric motor 2.

### Electric Motor

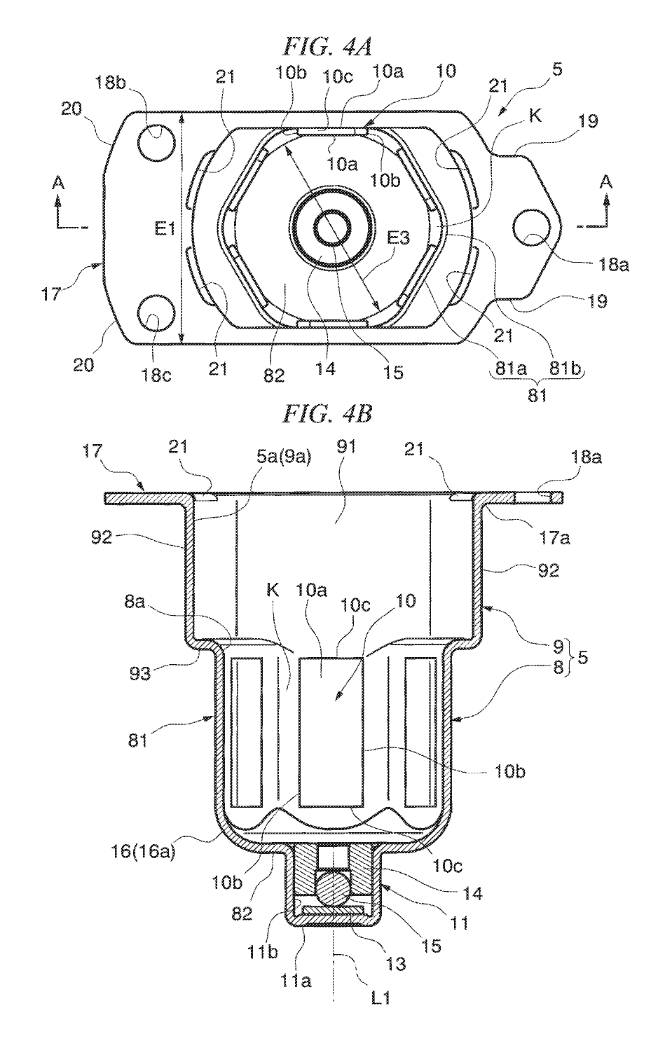

FIG. 4A and FIG. 4B show the motor case 5, FIG. 4A being a front elevation thereof, and FIG. 4B being a cross-sectional view thereof, along the line A-A of FIG. 4A.

As shown in detail in FIG. 3A, FIG. 3B, FIG. 4A, and FIG. 4B, the electric motor 2 is provided with an armature 6 that can freely rotate, within the motor case 5, which is shaped as a bottomed cylinder, and a brush holder unit 7 is fitted and held into the inside of the opening 5a in the motor case 5.

### Motor Case

The motor case 5 is formed by deep drawing using pressing operations or the like of a metal sheet, and has a yoke section 8 shaped as a bottomed cylinder, and a brush holder accommodating section 9 formed integrally on one end of the opening 8a of the yoke section 8 in the shape of an elongated circle. That is, the opening 9a of the brush holder accommodating section 9 is the opening 5a of the motor case 5.

The peripheral wall 81 of the yoke section 8 is formed as a hexagonal shape when seen in plan view in the axial direction, and has six flat sections 81a, and arc-shaped sections 81b that join the flat sections 81a. A segmented permanent magnet 10 is formed on the inside surface of each of the flat sections 81a. That is, the peripheral wall 81 of the yoke section 8 plays the role of forming a magnetic path between the permanent magnets 10, and is provided with the six permanent magnets 10.

The permanent magnets 10 are formed as flat sheets made of rare earth magnets, such as neodymium sintered magnets. The permanent magnets 10 are formed to have a rectangular shape extending in the axial direction when seen in plan view, and have front and rear surfaces 10a that are mutually opposing in the thickness direction, mutually parallel long surfaces 10b that are disposed at both ends of the front and rear surfaces 10a in the short direction, and mutually parallel short surfaces 10c that are disposed at both ends of the front and rear surface 10a in the long direction.

The arc-shaped sections 81b of the yoke section 8 are formed so as to correspond to the air gaps K formed between long surfaces 10b of the permanent magnets 10.

A bearing section 11 is integrally formed with the bottom wall 82 of the yoke section 8, protruding outwardly in the axial direction at substantially the center thereof. The bearing section 11 is formed to have the shape of a bottomed cylinder, and also so that the bottom wall 11a faces outwardly. The bearing section 11 rotatably supports one end of the rotary shaft 12. The bottom wall 82 is formed by a substantially round flat surface formed on the periphery of the bearing section 11.

A thrust plate 13 is placed on the bottom wall 11a inside the bearing section 11. A sliding bearing 14 is press fit and held in the inner peripheral surface 11b of the bearing section 11. Additionally, a steel ball 15 is provided between the thrust plate 13 and the sliding bearing 14. The thrust load of the rotary shaft 12 is received by the thrust plate 13 via the steel ball 15.

A circular section 16 having a substantially circular shape seen in plan view in the axial direction is formed over the region from the proximity of the bottom wall 82 of the peripheral wall 81 up to the bearing section 11 in the yoke section 8. By the formation of the circular section 16, a rounded section 16a is formed in the connecting section between the peripheral wall 81 and the bottom wall 82 (refer to FIG. 4B).

A brush holder accommodating section 9 that is integrally formed at an end of the opening 8a of the yoke section 8 is formed so as to be a substantially elongated circular shape in the axial direction, which is long in the direction that is perpendicular to the axial direction. The brush holder accommodating section 9 has a pair of flat walls 91 that are rectangularly shaped when seen in plan view and are disposed so as to be in opposition about the rotary shaft 12 as the center, and a pair of arc-shaped walls 92 that join both ends of the flat walls 91 in the peripheral direction, that is, the ends in the longitudinal direction.

The pair of flat walls 91 is provided so as to be flush with each of the flat sections 81a of the yoke section 8, which are disposed so as to be opposite, with the rotary shaft 12 as a center. A stepped wall 93 is formed between the arc-shaped wall of the brush holder accommodating section 9 and the peripheral wall 81 of the yoke section 8. The stepped wall 93 makes continuity from the peripheral wall 81 of the yoke section up until the arc-shaped wall 92 of the brush holder accommodating section 9.

An outer flange 17 for the purpose of connecting and holding the electric motor 2 to the worm reduction mechanism 3 is formed on the end of the opening 9a of the brush holder accommodating section 9. This outer flange 17 is formed in substantially the shape of a pentagon when viewed in plan view in the axial direction, lengthened along the longitudinal direction of the brush holder accommodating section 9, and also so that a part that is a vertex is positioned in the longitudinal direction.

The width E1 of the outer flange 17 in the short direction is set to be slightly larger than the distance between the pair of flat walls 91 of the brush holder accommodating section 9.

The part that is a vertex of and is on one end of the outer flange 17 in the longitudinal direction has formed on it one bolt hole 18a. Cutout parts 19 on either side of and sandwiching the bolt hole 8a are formed on one end of the outer flange 17 in the longitudinal direction.

A flat chamfered part 20 is formed on both sides of the other end of the outer flange 17 in the longitudinal direction. Bolt holes 18b and 18c are formed inside these flat chamfered parts 20 in the longitudinal direction.

Two depressions 21 each are formed on the inside of the connecting parts 17a between the outer flange 17 and the brush holder accommodating section 9. These depressions 21 are disposed so as to be distributed around the rotary shaft 12 as the center. The depressions 21 are for the purpose of positioning the brush holder unit 7 (to be described in detail later).

### Armature

As shown in FIG. 3A and FIG. 3B, the armature 6 provided so as to be freely rotatable inside the motor case 5 has an armature core 61 that is fitted over the outside at a position opposite the yoke section 8 of the rotary shaft 12, an armature coil 62, which is wound on the armature core 61, and a commutator 63, which is disposed at the other end of the rotary shaft 12 and also fitted over the outside at a position opposite the brush holder accommodating section 9. The armature core 61 is laminated in the axial direction with a plurality of ribbon-like metal plates 64.

Nine T-shaped teeth 65 are formed along the peripheral direction on the outer periphery of the metal plates 6 at a uniform spacing in a radial manner. The end parts of the teeth 65 extend in the peripheral direction, and are formed on the outer periphery of the armature core 61. That is, end parts of the teeth 65 are in a condition in which they oppose in the radial direction the front and rear 10a of the permanent magnets 10 that are disposed on the peripheral wall 81 of the yoke section 8.

Whereas the end parts of the teeth 65 are formed as arcs when seen in plan view in the axial direction, the front and rear surfaces 10a of the permanent magnets 10 that oppose them are formed to be flat. For this reason, moving from the center of the permanent magnet 10 toward the long side surface 10b in the peripheral direction, the air gap between the permanent magnet 10 and the armature core 61 gradually increases.

Insulators 67 are attached to the teeth 65 constituted as noted above. The insulators 67 are for the purpose of insulating the armature coils 62 from the armature core 61, and are formed to have a shape that is substantially a channel. Two insulators 67 are attached from the both sides in the axial direction of one tooth 65, and the overall teeth, with the exception of the end parts are covered by the insulators 67.

By fitting and holding a plurality of metal plates 64 over the outside of the rotary shaft 12, nine slots 66 that are shaped line ant paths that extend in the axial direction are formed between adjacent teeth 65 on the outer periphery of the armature core 61.

Windings 62a of enamel-covered wire are inserted between these slots 66, and the windings 62a are wound, via the insulators 67 that are made of an insulating material. By doing this, a plurality of armature coils 62 are formed on the outer periphery of the armature core 61.

The commutator 63 is fitted and fixed to the outer periphery of the other end of the rotary shaft 12. Nine segments 68 formed of an electrically conductive material are mounted to the outer peripheral surface of the commutator 63.

The segments 68 are pieces of metal plate that are long in the axial direction, and are mutually insulated and fixed in parallel with a uniform spacing therebetween along the peripheral direction.

The electric motor 2 of the first embodiment, therefore, has six permanent magnets 10, nine slots 66, and nine segments 68, making it a 6-pole, 9-slot, 9-segment electric motor.

An integrally formed a riser 69 that is bent to bend around towards the outer radius side is formed on the armature core 61 end of each segment 68. The winding 62a that is the beginning end of the armature coil 62 is hung over the riser 69 and the winding 62a is held to the riser 69 by fusing. By doing this, there is conductivity between a segment 68 and its corresponding armature coil 62.

### Brush Holder Unit

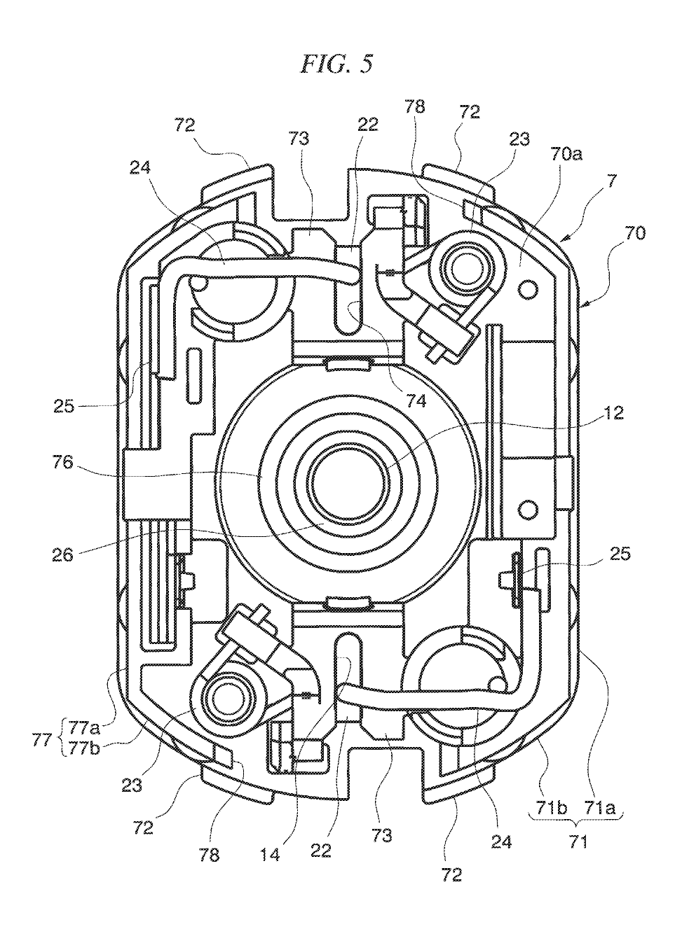

FIG. 5 is a plan view of the brush holder unit 7.

As shown in FIG. 3A and FIG. 3B, a brush 2 provided in the brush holder unit 7 accommodated by the brush holder accommodating section 9 makes sliding contact with the segments 68. The brush holder unit 7 has a box-shaped unit body 70 with an opening 70a. The unit body 70 is accommodated in the brush holder accommodating section 9 so that the opening 70a faces the armature core 61.

The bottom wall 71 of the unit body 70 closes off the opening 9a of the brush holder accommodating section 9 when the brush holder unit 7 is accommodated into the brush holder accommodating section 9. The bottom wall 71 of the unit body 70 is formed as an elongated circle, so as to match the cross-sectional shape of the brush holder unit 9, and has a pair of flat sides 71a and a pair of arc-shaped sides 71b.

A protrusion 72 is formed at four positions on the arc-shaped sides 71b that are opposite the depressions 21 formed in the brush holder accommodating section 9.

These protrusions 72 are formed with a size that can be placed into the depressions 21, and have a width in the peripheral direction that is slightly shorter than the width of the depressions 21. That is, the brush holder unit 7 is positioned in the axial direction by the protrusions 72 into the depressions 21 of the brush holder accommodating section 9.

Brush holder sections 73 are provided in the unit body 70, at the center part in the short direction and on both sides in the longitudinal direction. The brush holder sections 73 are formed with a shape that is substantially a cube that is open on the longitudinal direction end. The brush holder sections 73 are disposed so that the longitudinal direction thereof is along the radial direction.

Brushes 22 are provided within the brush holder sections 73 facing toward the center in the radial direction and so as to be able to freely protrude and be buried therewithin. For this reason, the brushes are disposed so as to be in opposition along the longitudinal direction of the unit body about the rotary shaft 12 as the center.

The brushes 22 make sliding contact with the segments 68 of the commutator 63 so as to supply electrical current to the armature coil 62. The brushes 22 are impelled toward the segments 68 by coil springs 23 disposed adjacently in the short direction of the brush holder section 73.

A slit 74 is formed in the brush holder section 73, along the longitudinal direction, on the surface opposite from the bottom wall 71 (the surface in front in FIG. 5). One end of a pigtail lead 24 is connected to each of the brushes 22 via the slit 74. The pigtail leads 24 are dressed in an L-shape when seen in plan view so as to run along the outer periphery of the bottom wall 71 from the brushes 22. The other ends of the pigtail leads 74 are connected to the power-supplying section 25 provided on the flat side 71a side of the bottom wall 71. The power-supplying section 25 is electrically connected to the connector unit 4.

Although it is not illustrated in FIG. 5, a smoothing capacitor to smooth the supplied electric current or a choke coil for noise suppression may be provided on the pigtail leads 24 running between the brushes 22 and the power-supplying section 25.

A protruding section 75 is formed on the bottom wall 71 of the unit body 70 facing the outside in the axial direction at the center part, that is, facing the side opposite from the armature core 61. At the center of the protruding section 75 is integrally formed a bearing section 76 that has a substantially spherical cross-section.

The bearing section 76 is for rotatably supporting the other end of the rotary shaft 12, and has a sliding bearing 26 press fit thereinto. The sliding bearing 26 has an outer shape that is substantially spherical, and inclines when the bearing section 76 is installed. By the inclined movement of the sliding bearing 26, it is possible to accommodate the rotary shaft 12 even if its axis is offset. A plurality of slits 76a are formed in the peripheral direction with a uniform spacing in the peripheral direction on the peripheral wall of the bearing section 76, so as to provide some degree of tolerance for manufacturing errors in the inner diameter of the bearing section 76 and the outer diameter of the sliding bearing 26.

The peripheral wall 77 of the unit body 70 is formed so as to rise upward from the outer peripheral part of the bottom wall 71. The peripheral wall 77 is the integral formation of one pair of flat sections 77a and one pair of arc-shaped section 77b linking the flat sections 77a, so as to follow along the outer peripheral surface of the brush holder accommodating section 9. That is, the peripheral wall 77 serves as a socket-and-spigot part for making a socket-and-spigot joining of the brush holder unit 7 with the brush holder accommodating section 9 of the motor case 5.

Openings 78 are formed at the centers of the arc-shaped sections 77b in the peripheral direction, that is, at positions on the arc-shaped sections 77b that are opposite the brush holder sections 73. By forming the openings 78, the task of installing the brushes 22 into the brush holder sections 73 is facilitated.

The other end of the rotary shaft 12 protrudes, via the sliding bearing 26 provided on the brush holder sections 73, toward the worm reduction mechanism 3. On this protruding other end of the rotary shaft 12 is mounted a joint motor 27 formed into a three-leafed shape.

The joint motor 27 forms one end of a joint unit 29 that transmits to the worm reduction mechanism 3 rotational force of the rotary shaft 12 to the worm reduction mechanism 3, and has a main section 51 that is substantially a circular plate. A square hole 52 is formed in a large part of the center of the main section 51 in the radial direction.

Two flat sections 53 are formed in the other end of the rotary shaft 12, these flat sections 53 being press fit into the square hole 52 of the main section 51 of the joint motor 27. By doing this, it is possible to join the rotary shaft 12 and the joint motor 27 so as to prevent mutual rotation and also so as to enable movement in the axial direction.

Protrusions 54 having substantially sector shapes seen in plan view in the axial direction are provided at three positions on the outer peripheral wall of the main section 51 facing outwardly in the radial direction. These protrusions 54, by mating removably with a joint frame 28 that is described later and that forms the other end of the joint unit 29, transmit the rotational force of the rotary shaft 12 to the worm reduction mechanism 3.

### Connector Unit

The electric motor 2 constituted as noted above is secured by bolts 105 and held to the worm reduction mechanism 3 with a connector unit 4 therebetween.

The connector unit 4 is for the purpose of making electrical connection between an external power supply (not shown) and the motor with a gear reduction 1. The connector unit 4 has a base section 41 formed as an elongated circle to oppose the bottom wall 71 of the brush holder unit 7, and a connection section 42 provided so as to protrude from one end of the base section 41.

An opening 43 through which the joint motor 27 can be passed is formed in the center of the base section 41 in the radial direction. A rising part 44 formed so as to rise upward substantially perpendicular toward the worm reduction mechanism 3 is formed on the connector section 42 side of the aperture 43 of the base section 41. A board 45 is fixed to the rising part 44.

A detection element (not shown) is mounted for the purpose of detection the rotational position of the connector unit 4 is mounted to the board 45. The detection signal from the detection element is output to an external controller via the connector section 42. Rotational control of the electric motor 2 is performed by this detection signal.

The connector section 42 has a cylindrical receptacle 46 that enables mating and removal of a connector (not shown) from an external power supply (not shown) or the like. One end of a plurality of terminals 47 used for a power supply or a sensor are provided so as to protrude inside the receptacle 46. The terminals 47 include those that make electrical connection with the board 45 by extending from the receptacle 46 up to the board 45 bent toward the worm reduction mechanism 3 side via the base section 41, and those that make electrical connection with the power-supplying section 25 of the brush holder unit 7 by extending from the receptacle 46 up to the power-supplying section 25 bent toward the electric motor 2 side via the base section 41.

Of the terminals 47, those that make connection to the board 45 are used as terminals for a sensor, and those that make connection to the power-supplying section 25 are used as terminals for a power supply. By doing this, the electrical power of an external power supply is supplied to the electric motor 2 via the brush holder unit 7.

### Worm Reduction Mechanism

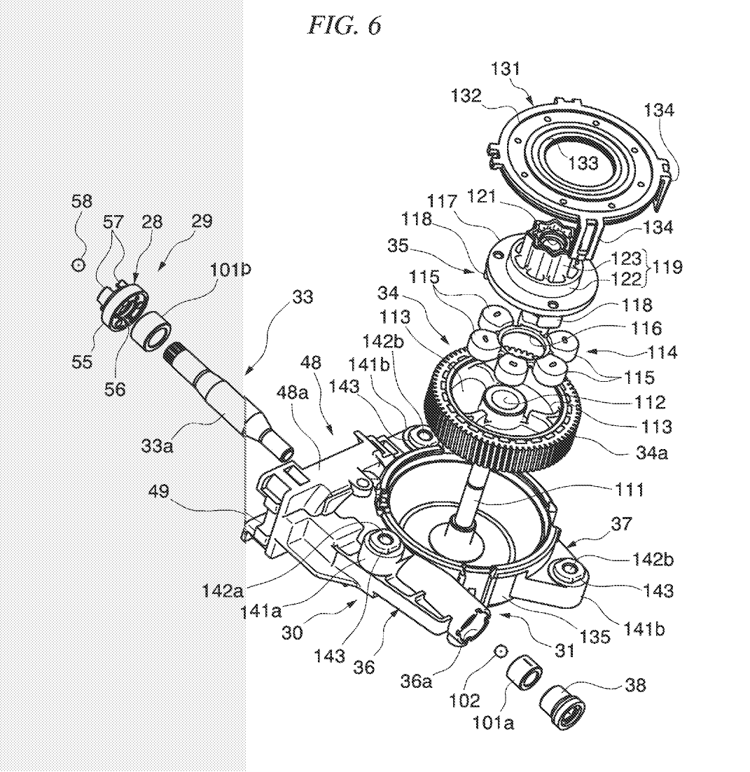

FIG. 6 is an exploded oblique view of the worm reduction mechanism 3.

As shown in FIG. 1, FIG. 2, and FIG. 6, the worm reduction mechanism 3 houses, within a gear casing 30, a worm shaft 33 that is linked to the rotary shaft 12 of the electric motor 2, a worm wheel 34 that meshes with the worm shaft 33, and a drive unit 35 that outputs the rotation of the worm wheel 34.

The gear casing 30 is an integral formation of a gear accommodating section 31 that accommodates the worm shaft 33, the worm wheel 34, and the drive unit 35 with the receiving section 48 that is disposed at a position corresponding to the electric motor 2 and that can receive the base section 41 of the connector unit 4.

The receiving section 48 is formed to have the shape of a box with an opening on the electric motor 2 side. The inner peripheral wall of the receiving section 48 is formed so as to have a cross-sectional shape that is substantially an elongated circle, so as to match the base section 41 of the connector unit 4. A depression 49 that receives the part of the connector unit 4 that connects the base section 41 and the connector part 42 is formed in the peripheral wall 48a of the receiving section 48.

The gear accommodating section 31 has a worm shaft accommodating section 36 for accommodating the worm shaft 33, and a worm wheel accommodating section 37 for accommodating the drive unit 35. A toothed part 33a is formed over a major portion of the center of the worm shaft 33 in the axial direction, this toothed part 33a meshing with the worm wheel 34.

The worm shaft accommodating section 36 is formed to have a substantially cylindrical shape, and extends along the axial direction of the rotary shaft 12. An end nut 38 is press fit into an opening 36a at the end of the worm shaft accommodating section 36 opposite from the receiving section 48, so as to block the opening 36a.

A sliding bearing 101a that rotatably supports one end of the worm shaft 33, and a steel ball 102 for receiving the thrust load of the worm shaft 33 are provided on the inside of the end nut 38. The sliding bearing 101a is pressed into and held in the receiving section 48. The steel ball 102 is prevented by the end nut 38 from falling off from the worm shaft accommodating section 36, and it is possible by the end nut 38 to adjust the position of the worm shaft 33 in the thrust direction.

The receiving section 48 side of the worm shaft accommodating section 36 passes and communicates with the receiving section 48. A sliding bearing 101b for rotatably supporting the other end of the worm shaft 33 is fit into and fixed to the receiving section 48 side end of the worm shaft accommodating section 36. The other end of the worm shaft 33 protrudes toward the receiving section 48 side via the sliding gear 101b. A location on this other end of the worm shaft 33 that protrudes is splined, and the joint frame 28 that forms the other side of the joint unit 29 is fit thereto by a spline mating.

The joint frame 28 has a main section 55 that is formed to be a substantially circular plate. At the center of the main section 55 in the radial direction is formed an insertion through hole 56 through which the other end of the worm shaft 33 can be passed. The insertion through hole 56 is splined, and by this the joint frame 28 and the worm shaft 33 are fit together by a spline mating.

Protrusions 57 that protrude along the axial direction are integrally formed with the surface of the main part 55 on the electric motor 2 side at three positions.

Each of the protrusions 57 is constituted so as to be interposed between the three protrusions 54 of the joint motor 27. That is, when the joint motor rotates by the drive of the electric motor 2, the protrusions 54 of the joint motor 27 and the protrusions 57 of the joint frame 28 engage in the peripheral direction, so that the joint motor 27 and the joint frame 28 rotate as one. In this manner, the joint motor 27 and the joint frame 28 are each formed so as to be attachable and removable in the axial direction and also to be able to engage in the rotational direction, so that the rotational force of the rotary shaft 12 is transmitted to the worm shaft 33.

A steel ball 58 is provided between the rotary shaft 12 and the worm shaft 33. This steel ball 58 makes direct contact with the rotary shaft 12 and the worm shaft 33, and plays the role of preventing an increase in sliding resistance therebetween, while also playing the role of restricting the axial direction of the shafts 12 and 38.

The worm wheel accommodating section 37 is formed to have a shape that is substantially a bottomed cylinder. A center shaft 111 that is inserted from the rear side (lower side in FIG. 6) and that protrudes toward the inside is provided at the bottom part 37a of the worm wheel accommodating section 37 at the center part in the radial direction. The worm wheel 34 is accommodated in the worm wheel accommodating section 37 in the condition in which it is rotatably supported by the center shaft 111.

The worm wheel 34 is formed to be substantially a circular plate, and has formed on the outer peripheral surface thereof a toothed part 34a that meshes with the worm shaft 33. At the center in the radial direction of the worm wheel 34 is formed an insertion through hole 112 for the passing through of the center shaft 111. The center shaft 111 passes through the worm wheel 34 and protrudes outwardly from the worm wheel 34.

Also, in the worm wheel 34, on the surface of the worm wheel accommodating section 37 that is opposite the bottom part 37a, there are formed, in the area surrounding the insertion hole 112, housing depressions 113 that are sector shaped when seen in plan view in the axial direction. By forming the housing depressions 113 at three positions on the worm wheel 34, three walls 113a are formed in a radial manner in the area surrounding the insertion through hole 11. Because each of the housing depressions 113 is formed to have a sector shape seen in plan view in the axial direction, the walls 113a broaden toward the outside in the radial direction from the inside in the radial direction when seen in plan view in the axial direction.

These housing depressions 113 house a rubber damper 114. The damper 114 is constituted by six damper pieces 115 disposed at a uniform spacing in the peripheral direction, and a ring part 116 that is disposed on the inside of the damper pieces 115 in the radial direction and that join the six damper pieces 115.

The damper pieces 115 are formed to have a semi-cylindrical shape in cross-section, and with a size so that two of the damper pieces 115 can be housed within one housing depression 113 of the worm wheel 34. By doing this, movement of the damper 114 in the direction of rotation is restricted by the walls 113a of the worm wheel 34.

The drive unit 35 is rotatably supported by the center shaft 111 on the opposite side of the worm wheel with the damper 114 therebetween. The drive unit 35 has a base plate 117 that is shaped substantially as a circular plate. The diameter of the base plate 117 is set to be a size that can cover over the end of the damper pieces 115 of the damper 114.

Protrusions 118 are formed so as to protrude at three positions spaced uniformly in the peripheral direction on the surface of the base plate 117 opposite the damper 114. Each of the protrusions 118 interposes between two damper pieces 115 that are housed in each of the housing depressions 113 of the worm wheel 34.

That is, when the worm wheel 34 rotates, the walls 113a of the worm wheel 34 and the protrusions 118 of the drive unit 35 engage in the peripheral direction, with the damper pieces 115 therebetween, so that the worm wheel 34 and the drive unit 35 rotate as one.

Because the rotational force of the worm wheel 34 is transmitted to the drive unit 35 via the damper 114, it is possible to soften the shock acting on the worm wheel 34 and the drive unit 35.

On the side of the base plate 117 opposite the damper 114, the output section 119 is provided so as protrude as a column. The output section 119 is constituted by a base section 122 that is a circular plate, and a linking section 123 that is provided so as to protrude from the base section 122. The linking section 123 is linked to, for example, a power window apparatus (not shown) of a vehicle. By doing this, the rotation of the worm wheel 34 can be transmitted to the power window apparatus.

An insertion through hole 121 for passing a shaft is provided in the output section 119 and in the base plate 117. The center shaft 111 is passes through this insertion through hole 121 and the drive unit 35 is rotatably supported.

A cover 131 having a shape that is substantially circular and that closes off the opening 37b is provided on the worm wheel accommodating section 37. The cover 131 prevents the intrusion of dust or water drops and the like into the inside of the worm wheel accommodating section 37, and also plays the role of restricting the movement of the drive unit 35 in the removal direction. The cover 131 has a cover piece 132 shaped substantially annularly, and the output section 119 of the drive unit 35 protrudes outward from the center of this cover piece 132.

A rubber sealing member 133 for improving the tight sealing inside the worm wheel accommodating section 37 is provided on the inner peripheral edge of the cover 131. By a sliding contact between this sealing member 133 and the base section 122 of the output section 119, it is possible to prevent the intrusion of dust or water drops and the like into the inside of the worm wheel accommodating section 37.

A plurality of engaging pieces 134 are provided on the outer peripheral edge of the cover 131. These engaging pieces 134 are formed so as to be elastically deformable, and extend outward toward the bottom part 37a of the worm wheel accommodating section 37, so as to run along the outer peripheral surface of the worm wheel accommodating section 37.

An engagement protrusion 135 is formed on the outer peripheral surface of the worm wheel accommodating section 37 at a position corresponding to the engagement pieces 134. By the engagement of this engagement protrusion 135 with an engagement piece 134, the cover 131 is fixed, and movement of the drive unit 35 in the direction of removal is restricted.

In addition, one bolt seat 141a is formed in the worm shaft accommodating section 36 of the gear casing 30, and bolt seats 141b are formed at two positions in the worm wheel accommodating section 37. These bolt seats 141a and 141b are used, for example, to tighten and hold the motor with a gear reduction 1 to a power window apparatus (not shown). The bolt seats 141a and 141b have insertion through holes 142a and 142b for passing bolts (not shown). Flanged bushings 143 are inserted into the insertion through holes 142a and 142b.

### Operating Effect

The operating effect of the motor with a gear reduction 1 is described below.

When electrical power is supplied to the electric motor 2 via the connector unit 4, a magnetic field is formed in the armature core 61, and magnetic forces of attraction and repulsion are generated with respect to the permanent magnets 10 disposed in the yoke section 8 so that the armature 6 rotates.

Because there is a skew with respect to the permanent magnet 10 axial direction and they are formed as flat sheets, proceeding from the center of the permanent magnets 10 toward the long surface 10b on both sides in the peripheral direction, the air gap between the permanent magnets 10 and the armature core 61 gradually increases.

For this reason, it is possible to reduce the change in the magnetic flux at the boundaries of the two ends of the permanent magnets in the peripheral direction, so that the cogging torque is reduced. By reducing the cogging torque, it is possible to reduce the vibration and noise when the electric motor 2 is driven.

By the rotation of the armature 6, the worm shaft 33 that is linked to the rotary shaft 12 via the joint unit rotates. Next, the worm wheel 34 that meshes with the worm shaft 33 rotates. When the worm wheel 34 rotates, the drive unit 35 that is formed as one therewith rotates. When this occurs, because the damper 114 is provided between the worm wheel 34 and the drive unit 35, the shock occurring between the worm wheel 34 and the drive unit 35 is softened.

In the case in which, for example, a power window apparatus (not shown) is linked to the drive unit 35, even if some external force is applied to the power window apparatus, because of the damper 114 the shock transmitted to the worm wheel 34 from the drive unit 35 can be softened.

### Effect

According to the first embodiment of the present invention, therefore, in a 6-pole, 9-slot, 9-segment electric motor 2, by using flat plates as the segmented permanent magnets 10, it is not necessary to perform complex processing of the permanent magnets 10. For this reason, even in the case, for example, in which a rare earth magnet such as neodymium sintered magnets are used as the permanent magnets 10, it is possible by machining to achieve thin permanent magnets 10. It is therefore possible to reduce both the weight and the cost of the permanent magnets 10, and to reduce the overall size of the electric motor 2.

In the motor case 5, the peripheral wall 81 of the yoke section 8 is formed so as to be hexagonal when seen in plan view in the axial direction, and the peripheral wall 81 is constituted by flat sections 81a and arc-shaped sections 81b. By then disposing the permanent magnets 10 on the flat sections 81a, it is possible to securely fix even flat plate permanent magnets 10 to the inner peripheral wall of the yoke section 8. Because an arc-shaped section 81b is formed between each of the flat sections 81a, it is possible to improve the rigidity of the yoke section 8 and to reduce the vibration or operating noise when the electric motor 2 is driven.

Additionally, it is possible to increase the outer diameter of the armature core 61 to the extent that the permanent magnets 10 are made thinner, without increasing the outer diameter of the yoke section 8. For this reason, it is possible to reserve more winding space for the winding 62a than conventionally, so that in forming the armature coil 62, it is possible to increase the number of winding turns, thereby enabling an improvement in the torque performance of the electric motor 2.

Additionally, by making the permanent magnets 10 flat plates, moving from the center the permanent magnet 10 to the long side surface 10b on both ends in the peripheral direction, the air gap between the permanent magnet 10 and the armature core 61 gradually increases. For this reason, it is possible to reduce the change in the forces of magnetic attraction and repulsion with respect to each of the teeth 65 of the armature 6 as they pass both ends of the permanent magnet 10, thereby enabling a reduction in the cogging torque.

By integrally forming the brush holder accommodating section 9 that accommodates the brush holder unit 7 with the yoke section 8, the motor case 5 is constituted by the yoke section 8 and the brush holder accommodating section 9. By doing this, the electric motor 2 can be made more compact than in the case of mounting a separate brush holder unit 7 to the electric motor 2.

The brush holder unit 7 is fitted to the brush holder accommodating section 9 using a socket-and-spigot joint, and a bearing section 76 that rotatably supports the other end of the rotary shaft 12 is integrally formed on the brush holder accommodating section 9. By doing this, it is not only possible to perform accurate positioning of the brush holder unit 7 with respect to the yoke section 8, but also easy to establish the position of each of the bearing sections 11 and 76 with the bearing section 11 formed on the yoke section 8 as the reference. It is therefore possible to perform precise relative positioning of the bearing sections 11 and 76. It is therefore possible to prevent undue stress from being applied to the rotary shaft 12 or the bearing sections 11 and 76. In addition, it is possible to prevent an increase in the torque load on the rotary shaft 12 due to relative offset between the bearing sections 11 and 76, thereby enabling an improvement in the motor characteristics of the electric motor 2.

In addition to forming the brush holder accommodating section 9 to have substantially the shape of an elongated circle in the axial direction, the brush holder unit 7 that is accommodated in the brush holder accommodating section 9 is formed to have a shape that is substantially an elongated circled seen in plan view in the axial direction. The flat walls 91 of the brush holder accommodating section 9 and the flat sections 81a of the yoke section 8 that are disposed so as to be opposite about the rotary shaft 12 as the center are formed so as to be mutually flush. By doing this, it is possible to make an electric motor 2 that overall flat and compact.

Also, by disposing each of the brush holder sections 73 in the center of the brush holder unit 7 in the axial direction and on both ends in the longitudinal direction, it is possible to make an electric motor 2 that is further flattened and compact.

In addition, coil springs 23 that impel the brushes 22 toward the commutator 63 are disposed so as to be adjacent thereto in the short direction of the brush holder section 73. For this reason, compared with the case of disposing a resilient member (spring) that impels the brushes 22 on the end part in the longitudinal direction, it is possible to make the length of the brush holder section 73 shorter. It is therefore possible to make the length of the brush holder unit 7 shorter.

Additionally, an outer flange 17 is formed on the opening 9 end of the brush holder accommodating section 9, and a depressions 21 are formed in the connecting parts 17a between the outer flange 17 and the arc-shaped wall 92 of the brush holder accommodating section 9. Protrusions 72 are formed at position that correspond to the depressions 21 of the brush holder unit 7. By placing the protrusions 72 in the depressions 21 of the brush holder accommodating section 9 at the time of assembling the brush holder unit 7, it is possible to easily and accurately position the brush holder unit 7 in the axial direction.

For this reason, the precision of assembling the brush holder unit and the ease of the task of assembly are improved.

A circular section 16 having a substantially circular shape seen in plan view in the axial direction is formed over the region from the proximity of the bottom wall 82 of the peripheral wall 81 up to the bearing section 11 in the yoke section 8. By the formation of the circular section 16, a rounded part 16a is formed in the connecting part between the peripheral wall 81 and the bottom wall 82 (refer to FIG. 4B).

In the case forming the motor case 5 by deep drawing by pressing operations or the like, there is the risk that the metal plate used as the blank is pulled to the flat section 81a on the peripheral wall 81, thereby worsening the roundness of the bearing section 11. Also, to improve the roundness of the bearing section 11, the number of pressing operations increases, thereby risking an increase in the processing cost.

However, because of the formation of the circular section 16 on the motor case 5, the bearing section 11 is uniformly pulled over the entire outer periphery at the time of deep drawing. Also, because it is possible by the rounded part 16a to achieve a large spacing between the bearing section 11 and the peripheral wall 81, it is possible to reduce the influence on the roundness of the bearing section 11 by the formation the peripheral wall 81. For this reason, it is easy to improve the roundness of the bearing section 11, and possible to reduce the processing cost.

Additionally, the rotary shaft 12 of the electric motor 2 and the worm shaft 33 of the worm reduction mechanism 3 are linked via the joint unit 29. For this reason, even in the case of mounting the electric motor 2 not to the worm reduction mechanism 3, but rather to another reduction mechanism or external apparatus, the need to redesign the rotary shaft 12 of the electric motor 2 is eliminated. For this reason, the general usefulness of the electric motor 2 is improved. Furthermore, by mounting the joint motor 27 that forms one side of the joint unit to the rotary shaft 12 of the electric motor 2 beforehand, the assembly of the electric motor 2 and worm reduction mechanism 3 is facilitated, and the ease of assembly is improved.

In the first embodiment described above, although the description was for the case in which segmented permanent magnets 10 are formed as flat plates from rare earth magnets such as neodymium sintered magnets and also formed to have substantially a rectangular shaped when seen in plan view, and to be long in the axial direction, this is not a restriction, and the permanent magnets 10 may be formed using neodymium bonded magnets or ferrite magnets.

### Second Embodiment

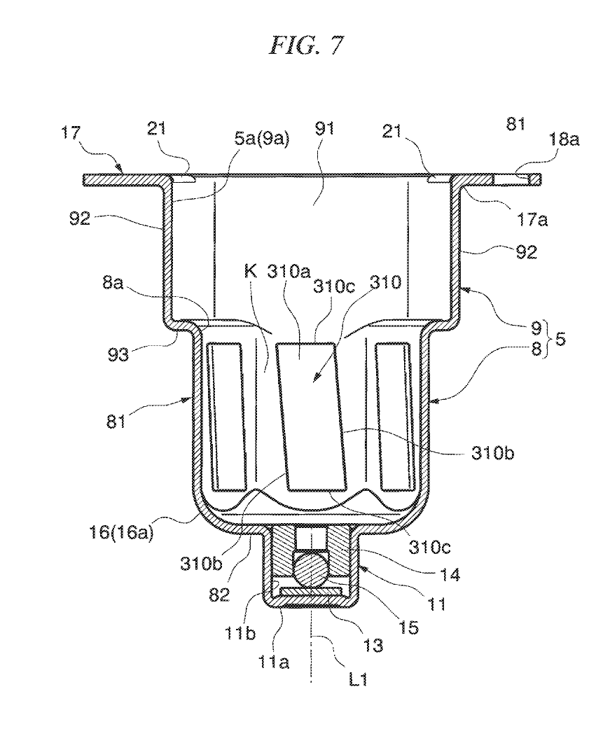

Next, the second embodiment of the present invention will be described, based on FIG. 7.

FIG. 7 is a vertical cross-sectional view of the motor case of the second embodiment. Aspects that are the same as in the first embodiment are described with the assignment of the same reference numerals and the descriptions thereof are omitted (this is true of the other embodiments to follow).

In the second embodiment, the motor with a reduction gear 1 is used as the drive source for, for example, a power window apparatus of a vehicle, and has an electric motor 2 and a worm reduction mechanism 3 linked to a rotary shaft 12 of the electric motor 2. The basic features such as provision of a connector unit for the purpose of supplying electrical power to the electric motor 2, the brush holder unit 7 being fitted into a held in the opening 5a side of the motor case 5, the rotatable provision of an armature 6 on the opening 5a side of the motor case 5, the constitution as an electric motor having 6 poles, 9 slots, and 9 segments, the worm reduction mechanism 3 having housed within a gear casing 30 a worm shaft 33 linked to the rotary shaft 12 of the electric motor, a worm wheel 34 meshing with the worm shaft 33, and a drive unit 35 that outputs the rotation of the worm wheel 34 are the same as in the first embodiment (this applying to the other embodiments to follow).

As shown in FIG. 7, the point of difference between the first embodiment and the second embodiment is that, whereas the permanent magnets 10 of the above-described first embodiment are formed so as to be substantially rectangular when seen in plan view and long in the axial direction, the permanent magnets 310 of the second embodiment are formed to have a shape that is substantially a parallelogram when seen in plan view and long in the axial direction.

More specifically, the permanent magnets 310 are disposed so that the long side surfaces 310b thereof are inclined with respect to a straight line L1 that is along the axial direction, and also so that the one surface of the front and rear surfaces 310a makes contact with a flat section 81a of the yoke section 8. The permanent magnets 10 are arranged in a row so that one short side surface 301c of each is positioned on the one and the same flat plane. That is, the permanent magnets 310 are in a skewed condition.

According to the above-described second embodiment, therefore, it is possible to achieve the same type of effect as with the above-described first embodiment. In addition, the permanent magnets 310 are formed so as to be in the shape of parallelograms seen in plan view and are disposed so as to be skewed with respect to the teeth 65 of the armature 6.

### Third Embodiment

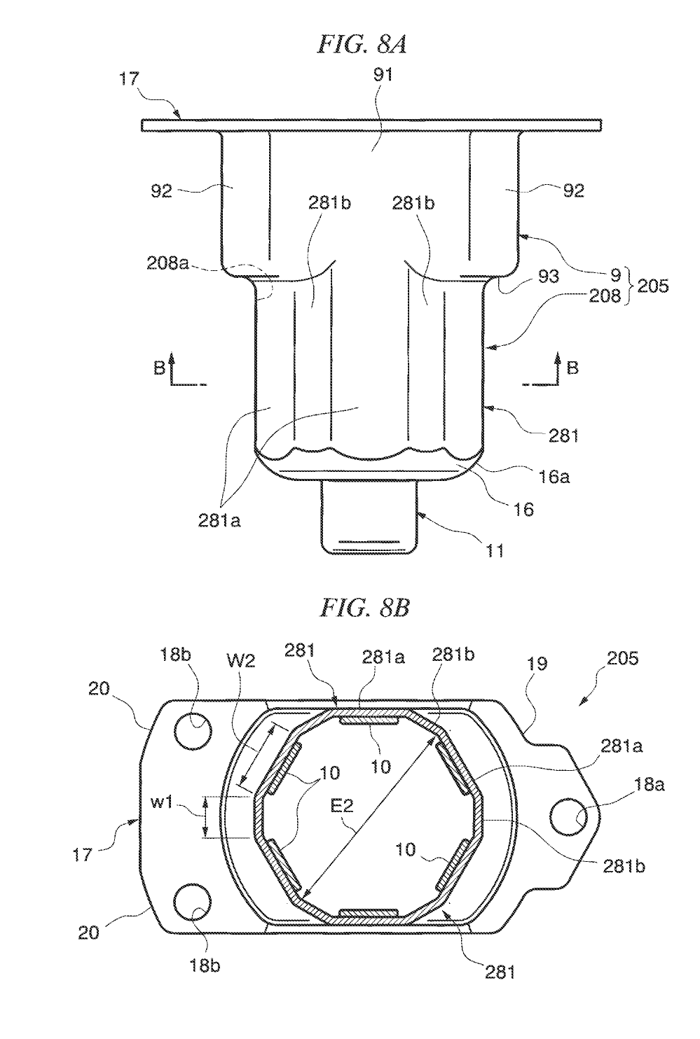

Next, the third embodiment of the present invention will be described, based on FIG. 8A and FIG. 8B.

FIG. 8A and FIG. 8B show a motor case 205 of the third embodiment, FIG. 8A being a side view, and FIG. 8B being a cross-sectional view along the line B-B in FIG. 8A.

As shown in FIG. 8A and FIG. 8B, the point of difference between the first embodiment and the third embodiment is that, whereas in the first embodiment the yoke section 8 is formed with a shape that is substantially hexagon seen in plan view in the axial direction, the yoke section 208 in the third embodiment is formed with a shape that is substantially a dodecagon seen in plan view in the axial direction.

The motor case 205 is formed by deep drawing a metal plate by pressing operations and the like, and is constituted by a yoke section 208 that is a bottomed cylindrical shape, and a brush holder accommodating section 9 in the shape of an elongated circle formed integrally with the end of an opening 208a of the yoke section 208.

The peripheral wall 281 of the yoke section 208 is constituted by six first flat sections 281a formed instead of the flat sections 81a of the peripheral wall 81 of the yoke section 8 in the first embodiment, and six second flat sections 281b formed instead of the arc-shaped sections 81b.

The first flat sections 281a and the second flat sections 281b are in the condition of being alternately disposed in the peripheral direction. Because the second flat sections 281b are formed in place of the arc-shaped sections of the first embodiment, the width W1 thereof in the peripheral direction is set to be smaller than the width W2 of the first flat sections 281a in the peripheral direction.

A segmented permanent magnet 10 is disposed on each of the first flat sections 281a. The permanent magnets 10 may be formed with a shape that is substantially a parallelogram seen in plan view that is long in the axial direction, and may alternatively be formed as rectangles.

According to the third embodiment, therefore, in addition to the same type of effect as with the first embodiment, the yoke section 208 is smaller than the yoke section 8 of the first embodiment to the extent that the yoke section 208 is formed to have a shape that is substantially a dodecagon seen in plan view in the axial direction.

More specifically, second flat sections 281b are formed in the peripheral wall 281 of the yoke section 208 instead of the arc-shaped sections 81b that are formed in the first embodiment. By doing this, the second flat sections 281b are positioned more toward the inside in the radial direction than the arc-shaped sections 81b. That is, the yoke section 208 is in form of the yoke section 8 of the first embodiment, but with the corners (arc-shaped sections 81b) pressed in. For this reason, the distance E2 (refer to FIG. 8B) between opposing angles about the rotary shaft 12 as the center can be made smaller than the distance E3 (refer to FIG. 4A) between the arc-shaped sections 81b opposing about the rotary shaft 12 as the center in the yoke section 8 of the first embodiment.

### Fourth Embodiment

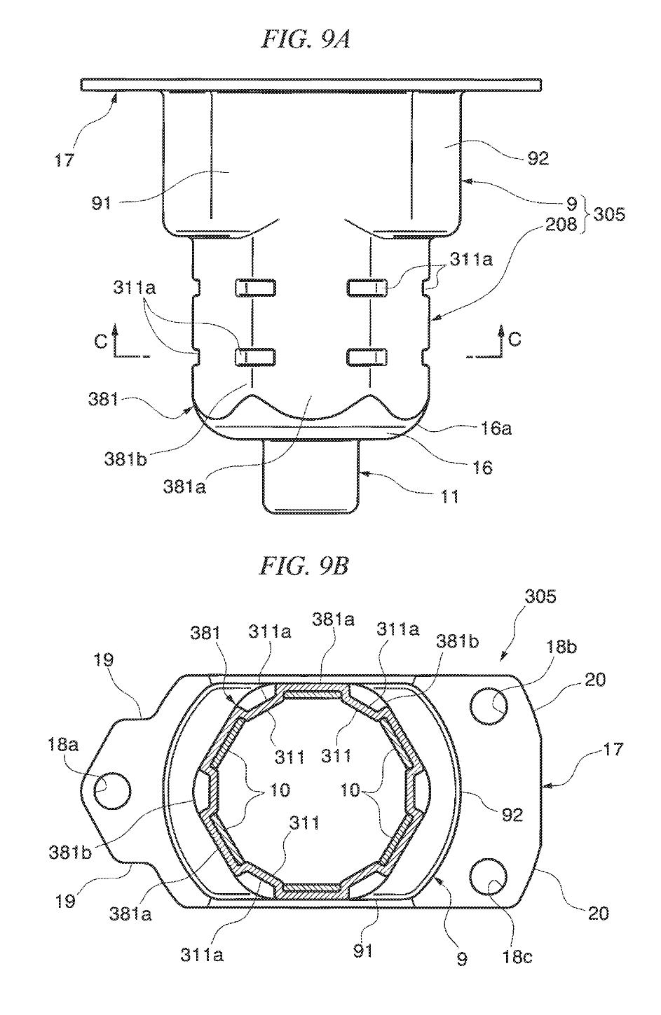

Next, the fourth embodiment of the present invention will be described, base on FIG. 9A and FIG. 9B.

FIG. 9A and FIG. 9B show a motor case 305 of the fourth embodiment, FIG. 9A being a side view, and FIG. 9B being a cross-sectional view along the line C-C in FIG. 9A.

As shown in FIG. 9A and FIG. 9B, the point of difference between the first embodiment and the fourth embodiment is that positioning protrusions 311 for positioning the permanent magnets 310 are formed on the yoke section 8 of the first embodiment.

More specifically, the peripheral wall 381 of the yoke section 308 in the motor case 305 is formed to have a shape that is substantially hexagonal seen in plan view in the axial direction, and is constituted by six flat sections 381a and arc-shaped sections 381b that are linked to these flat sections 381a. The permanent magnets 10 are provided on the inner surface of each of the flat sections 381a.

A plurality of positioning protrusions 311 are provided on the arc-shaped sections 381b of the yoke section 308 so as to protrude toward the inside in the radial direction. Two positioning protrusions 311 are formed along the axial direction on each arc-shaped section 381b, and positioning protrusions 311 that are adjacent in the peripheral direction are positioned on one and the same flat plane. The positioning protrusions 311 are formed by using a fixture or the like to press the arc-shaped sections 381b inwardly in the radial direction from the outside in the radial direction. For this reason, depressions 311a are formed in the outer periphery of the arc-shaped sections 381b at locations opposite the positioning protrusions 311.

The permanent magnet 10 disposed on each flat section 381 is formed so that the permanent magnet 10 is securely sandwiched by the positioning protrusions 311 positioning the both sides of the permanent magnet 10. That is, each positioning protrusions 311 is formed between each of the permanent magnets 10, and the positioning of the permanent magnet 10 in the peripheral direction is performed.

According to the above-described fourth embodiment, therefore, in addition to the same type of effect as with the first embodiment, it is possible to easily position the permanent magnets 10. For this reason, it is possible to improve the ease of the task of mounting the permanent magnets 10.

Although the above-described fourth embodiment is for the case of forming two each of the positioning protrusions 311 along the axial direction on each of the arc-shaped sections of the yoke section 308 and disposing the permanent magnets 10 having a shape that is substantially rectangular seen in plan view on the flat sections 381a, this is not a restriction, and the two positioning protrusions 311 formed on each of the arc-shaped sections 381b of the yoke section 308 may be disposed so as to be offset in the axial direction, and permanent magnets 310 having a shape that is substantially a parallelogram seen in plan view may be used in place of the permanent magnets 10 that are substantially rectangular seen in plan view.

### Fifth Embodiment

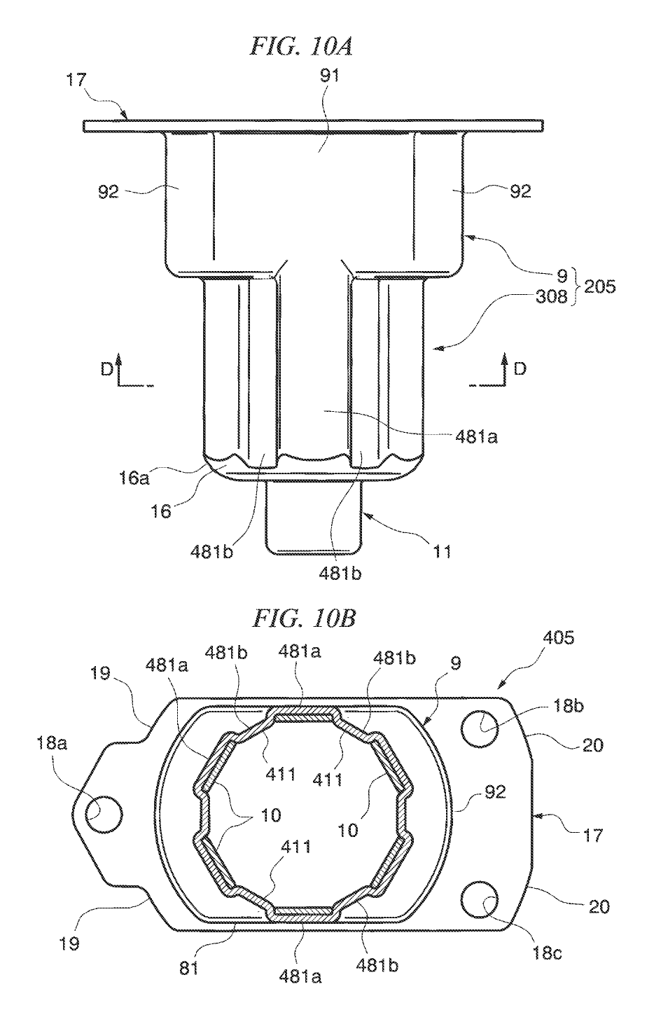

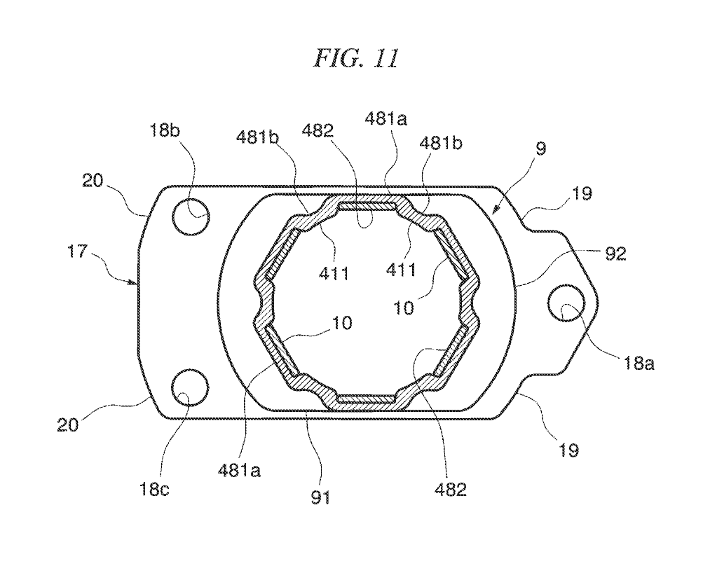

Next, the fifth embodiment of the present invention will be described, based on FIG. 10A, FIG. 10B, and FIG. 11.

FIG. 10 and FIG. 10B show the motor case 405 of the fifth embodiment, with FIG. 10A being a side view and FIG. 10B being a cross-sectional view along the line D-D in FIG. 10A.

As shown in FIG. 10A and FIG. 10B, the point of difference between the fourth embodiment and the fifth embodiment is that, whereas the motor case 305 in the fourth embodiment had formed a plurality of positioning protrusions for positioning the permanent magnets 10 in the yoke section 308 in the peripheral direction, the motor case 405 in the fifth embodiment has positioning ridges 411 in the yoke section 408 in place of the positioning protrusions 311.

The positioning ridges 411 are formed on the inner surface 481 of the yoke section 40 so as to pass in the axial direction across each of the flat sections 481a. That is, the peripheral wall 481 of the yoke section 408 is constituted by the flat sections 481a and the positioning ridges 411. The flat sections 481 a and the positioning ridges 411 are disposed alternately in the peripheral direction.

The positioning ridges 411 are formed using a fixture or the like to press the peripheral wall 481 inwardly in the radial direction from the outside in the radial direction. For this reason, depressions 481b are formed in the peripheral direction in the peripheral wall 481 between each of the flat sections 481a.

According to the above-described fifth embodiment, therefore, it is possible to achieve the same type of effect as with the fourth embodiment. In addition, because the positioning ridges 411 are formed so as to pass over the entire peripheral wall 481 in the axial direction, the short direction sides of the permanent magnets are securely sandwiched. For this reason, it is possible to perform reliable positioning of the permanent magnets 10.

The above-described fifth embodiment is described for the case in which the peripheral wall 481 is pressed inwardly in the radial direction from the outside in the radial direction using a fixture or the like, so as to form the positioning ridges 411. Additionally, the description is for the case in which the permanent magnets 10 are disposed on the flat sections 481a of the peripheral wall 481. In this case, as shown in FIG. 11, a machined part 482 may be formed on the inner surface of the flat section 481 by cutting, so as to enable more precise positioning of the permanent magnets 10.

FIG. 11 is a side cross-sectional view of another form of the yoke section 40 of the fifth embodiment.

As shown in FIG. 11, in the case of forming the machined parts 482 in the inner surface of the flat sections 481a by cutting, the need to form the positioning ridges 411 precisely is eliminated. Also, in the case in which the machined parts 482 are formed in the inner surface of the flat sections 481a, it is desirable to set the material thickness of the peripheral wall 481 of the yoke section 408 to a thickness that accounts for the allowance for machining

In the above-described fifth embodiment, the description is for the case in which the positioning ridges 411 are formed so as to run along the axial direction. This is not a restriction, however, and the positioning ridges 411 may be formed at an inclination with respect to the axial direction. By doing this, it is possible to dispose the permanent magnets 310 that have a shape that is substantially a parallelogram seen in plan view on the flat sections 481a in place of the permanent magnets 10 having a shape that is substantially rectangular seen in plan view.

The present invention is not restricted to the above-described embodiments, which may be subjected to various modifications, within the scope of the present invention.

Additionally, in the above-described embodiments, the descriptions are for the case in which, in the motor cases 5, 205, 305, and 405, two each of depressions 21 are formed in the connection parts 17a between an outer flange 17 and the arc-shaped wall 92 of the brush holder accommodating section 9, and in which four protrusions 72 that correspond to the depressions 21 are formed in the brush holder unit 7. This is not a restriction, however, and at least one depression 21 can be formed in the brush holder accommodating section 9, with at least one protrusion 72 formed in the brush holder unit 7.

In the above-described embodiments, the descriptions are for the case in which the depressions 21 are formed in the connecting parts 17a with the arc-shaped walls 92 of the brush holder accommodating section 9 and protrusions 72 are formed in positions of the brush holder unit 7 that correspond to the depressions 21, and when the brush holder unit 7 is assembled, by placing the protrusions 72 into the depressions 21 of the brush holder accommodating section 9, positioning of the brush holder unit 7 in the axial direction is done (refer to FIG. 2). These are not restrictions, however, and the peripheral wall 77 of the brush holder unit 7 may be caused to make contact with the stepped wall 93 (refer to FIG. 4B) formed between the arc-shaped wall 92 of the brush holder accommodating section 9 and the peripheral wall 81 of the yoke section 8 so as to perform positioning in the axial direction. In this case, the depressions 21 need not be formed in the motor cases 5, 205, 305, and 405, and the protrusions 72 need not be formed in the brush holder unit 7.

Also, in the above-described embodiments, the descriptions are for the case in which a worm reduction mechanism 3 is linked to the electric motor 2. This is not a restriction, however, and in place of a worm reduction mechanism 3 linked to the electric motor 2, an actuator mechanism using a trapezoidal screw other external equipment, for example, may be linked thereto.

### INDUSTRIAL APPLICABILITY

The present invention, in addition to enabling the achievement of light weight, compactness, and low cost using the smallest required permanent magnets while reducing the cogging torque, can be applied to an electric motor capable of improving performance, and to a motor with a gear reduction.

### REFERENCE SYMBOLS

1 Motor with a reduction gear
2 Electric motor
3 Worm reduction mechanism
4 Connector unit
5, 205, 305, 405 Motor case
6 Armature
7 Brush holder unit
8, 208, 308, 408 Yoke section (yoke)
8a, 9a, 208a Opening
9 Brush holder accommodating section
10, 310 Permanent magnet
11 Bearing section (first bearing section)
12 Rotary shaft
16 Circular section
17 Outer flange
17a Connecting part
21 Depression
22 Brush
23 Coil spring (resilient member)
27 Joint motor (linking part)
28 Joint frame
29 Joint unit
33 Worm shaft
34 Worm wheel
61 Armature
62 Armature coil
62a Winding
63 Commutator
65 Teeth
66 Slot
68 Segment
72 Protrusion
76 Bearing section (second bearing section)
77, 81, 281, 381, 481 Peripheral wall
77a, 81a, 381a, 481a Flat part
77b, 381b Arc-shaped part
82 Bottom wall
91 Flat wall
92 Arc-shaped wall
93 Stepped wall
281a First flat section
281b Second flat section
311 Positioning protrusion
411 Positioning ridge (position protrusion)

1. An electric motor comprising:
a bottomed cylindrical yoke;
six flat-sheet permanent magnets fixed to an inner peripheral surface of the yoke;
an armature rotatably supported further inward in the radial direction from the permanent magnets, and
one pair of brushes which supply electricity to the armature,
wherein
the armature has
a rotary shaft;
an armature core which is fitted and fixed to the outside of the rotary shaft; and
a commutator provided adjacently to the armature core with nine segments disposed in the peripheral direction, and
the armature core has:
nine teeth extending toward the outside in the radial direction and
9 slots formed between the teeth and extending along the axial direction,
wherein
windings are wound around each of the teeth and the end part of the windings connected to the segments,
the permanent magnets are disposed on flat sections of a peripheral wall of the yoke, which is formed to be polygonal seen in plan view in the axial direction,
a first bearing section which rotatably supports one end of the rotary shaft is integrally formed on a bottom part of the yoke,
a brush holder accommodating section capable of accommodating a brush holder unit that holds the brushes is integrally formed at an opening of the yoke, and
electricity is supplied to the windings by a sliding contact by the brushes with the segments.

2. The electric motor according to claim 1, wherein
the brush holder unit is formed to enable fitting and holding inside the brush holder accommodating section, and
a second bearing unit which rotatably supports the other end of the rotary shaft is integrally formed on the brush holder unit.

3. The electric motor according to claim 1, wherein
the brush holder unit and the brush holder accommodating section are formed to have a shape that is an elongated circle seen in plan view, a peripheral wall of the brush holder accommodating section having two flat sections and arc-shaped sections that link the flat sections in the peripheral direction, wherein
of the flat sections of the yoke, two flat sections that are in mutual opposition with the rotary shaft as the center and
a flat section of the brush holder accommodating section are flush.

4. The electric motor according to claim 3, wherein the one pair of brushes are disposed, on both ends in the longitudinal direction of the brush holder unit, to be in opposition about the rotary shaft as the center, and a resilient member which impels the brushes toward the commutator is provided in the brush holder unit.

5. The electric motor according to claim 1, wherein
an outer flange is integrally formed at the opening edge of the brush holder accommodating section,
a depression is formed at least at one position in a connecting part between the peripheral wall of the brush holder accommodating section and the outer flange, and
a protrusion capable of being placed in the depression is provided in the outer peripheral edge of the brush holder unit.

6. The electric motor according to claim 1, wherein in the yoke a circular section having a shape that is substantially circular seen in plan view in the axial direction is formed in a region between the proximity of the bottom wall of the peripheral wall and the first bearing section.

7. The electric motor according to claim 1, wherein the permanent magnets are formed to be long in the axial direction and also are disposed so that sides in the short direction are at an inclination with respect to a straight line along the axial direction.

8. The electric motor according to claim 1, wherein the peripheral wall of the yoke is formed to be a hexagon seen in plan view in the axial direction.

9. The electric motor according to claim 1, wherein the peripheral wall of the yoke is formed to be a dodecagon seen in plan view in the axial direction.

10. The electric motor according to claim 1, wherein a positioning protrusion is formed on the inner surface of the peripheral wall of the yoke, between each permanent magnet.

11. The electric motor according to claim 1, wherein
the other end of the rotary shaft protrudes from the brush holder unit, and a linking section which transmits rotation of the rotary shaft to an external apparatus is provided at protruding position, and
the linking section can be attached to and removed from the external apparatus.

12. A motor with a gear reduction comprising:
the motor of claim 1 and
an external apparatus provided with a reduction mechanism, wherein
the other end of the rotary shaft protrudes from the brush holder unit, and a linking section which transmits rotation of the rotary shaft to the external apparatus is provided at protruding position, and
the reduction mechanism and the rotary shaft of the armature are linked via the linking section.
